(19) United States
(12) Patent Application Publication
(10) Pub. No.: US 2025/0205889 A1
(43) Pub. Date: Jun. 26, 2025

(54) DETERMINATION OF POSITIONAL RELATIONSHIP BETWEEN WORKPIECE AND ROBOT

(71) Applicant: KABUSHIKI KAISHA YASKAWA DENKI, Kitakyushu-shi (JP)

(72) Inventors: Ryo KABUTAN, Fukuoka (JP); Makoto TAKAHASHI, Fukuoka (JP)

(73) Assignee: KABUSHIKI KAISHA YASKAWA DENKI, Kitakyushu-shi (JP)

(21) Appl. No.: 18/954,615

(22) Filed: Nov. 21, 2024

(30) Foreign Application Priority Data
Dec. 21, 2023 (JP) 2023-216158

(51) Int. Cl. B25J 9/16

(52) U.S. Cl. CPC B25J 9/1664; B25J 9/163; B25J 9/1697

(57) ABSTRACT

A control assistance system includes circuitry configured to: virtually execute, for each of a plurality of candidate positional relationships that are candidates for the relative positional relationship between the workpiece in which a plurality of working areas is set and the robot, a predetermined process in at least one of the working areas by an end effector of the robot placed in the candidate positional relationship, by a simulation based on a workpiece model indicating the plurality of working areas and a robot model indicating the robot; identify, for each of the plurality of candidate positional relationships, a set of one or more of the working areas having processed under the candidate positional relationship in the simulation, as a working area set; and determine the relative positional relationship from the plurality of candidate positional relationships based on the working area set of each of the plurality of candidate positional relationships.

### CROSS-REFERENCE TO RELATED APPLICATIONS

This application is based upon and claims the benefit of priority from Japanese Patent Application No. 2023-216158, filed on Dec. 21, 2023, the entire contents of which are incorporated herein by reference.

### BACKGROUND

### Field

One aspect of the present disclosure relates to a control assistance system, a control assistance method, and a control assistance program.

### Description of the Related Art

Japanese Unexamined Patent Application Publication No. 2022-181174 describes a robot system for picking up one object from a group of objects using a robot. This system includes a camera that provides an image of an object, a deep learning neural network that generates a segmented image of the object, a means for identifying a place for picking up the object using the segmented image, and a means for rotating the object using an orientation of the object in the segmented image.

### SUMMARY

A control assistance system according to an aspect of the present disclosure assists control of a robot capable of changing a relative positional relationship between a workpiece and the robot that processes the workpiece. The control assistance system includes circuitry configured to: acquire a workpiece model indicating a plurality of working areas of the workpiece; acquire a robot model indicating the robot having an end effector; virtually execute, for each of a plurality of candidate positional relationships that are candidates for the relative positional relationship between the workpiece and the robot, a predetermined process in at least one of the working areas by the end effector of the robot placed in the candidate positional relationship, by a simulation based on the workpiece model and the robot model; identify, for each of the plurality of candidate positional relationships, a set of one or more of the working areas having processed under the candidate positional relationship in the simulation, as a working area set; determine the relative positional relationship from the plurality of candidate positional relationships based on the working area set of each of the plurality of candidate positional relationships; and control the robot placed in a real working space, based on the determined relative positional relationship.

A control assistance method according to an aspect of the present disclosure is executable by a control assistance system that includes at least one processor and assists control of a robot capable of changing a relative positional relationship between a workpiece and the robot that processes the workpiece. The method includes: acquiring a workpiece model indicating a plurality of working areas of the workpiece; acquiring a robot model indicating the robot having an end effector; virtually executing, for each of a plurality of candidate positional relationships that are candidates for the relative positional relationship between the workpiece and the robot, a predetermined process in at least one of the working areas by the end effector of the robot placed in the candidate positional relationship, by a simulation based on the workpiece model and the robot model; identifying, for each of the plurality of candidate positional relationships, a set of one or more of the working areas having processed under the candidate positional relationship in the simulation, as a working area set; determining the relative positional relationship from the plurality of candidate positional relationships based on the working area set of each of the plurality of candidate positional relationships; and controlling the robot placed in a real working space, based on the determined relative positional relationship.

A non-transitory computer-readable storage medium according to an aspect of the present disclosure stores processor-executable instructions for causing a computer to function as a control assistance system that assists control of a robot capable of changing a relative positional relationship between a workpiece and the robot that processes the workpiece. The instructions cause the computer to execute: acquiring a workpiece model indicating a plurality of working areas of the workpiece; acquiring a robot model indicating the robot having an end effector; virtually executing, for each of a plurality of candidate positional relationships that are candidates for the relative positional relationship between the workpiece and the robot, a predetermined process in at least one of the working areas by the end effector of the robot placed in the candidate positional relationship, by a simulation based on the workpiece model and the robot model; identifying, for each of the plurality of candidate positional relationships, a set of one or more of the working areas having processed under the candidate positional relationship in the simulation, as a working area set; determining the relative positional relationship from the plurality of candidate positional relationships based on the working area set of each of the plurality of candidate positional relationships; and controlling the robot placed in a real working space, based on the determined relative positional relationship.

### BRIEF DESCRIPTION OF THE DRAWINGS

FIG. 1 is a diagram showing an example application of a control assistance system.

FIG. 2 is a diagram showing an example of relative positional relationships determined by a system.

FIG. 3 is a diagram showing an example functional configuration of the control assistance system.

FIG. 4 is a diagram showing an example hardware configuration of a computer used for the control assistance system.

FIG. 5 is a flowchart showing an example process executed by the control assistance system.

FIG. 6 is a diagram showing an example method of determining a relative positional relationship.

FIG. 7 is a diagram showing an example iterative process for determining a relative positional relationship and setting a working area group.

### DETAILED DESCRIPTION

In the following description, with reference to the drawings, the same reference numbers are assigned to the same components or to similar components having the same function, and overlapping description is omitted.

### Overview of System

A control assistance system according to the present disclosure is a computer system that assists in controlling a robot capable of changing a relative positional relationship between a workpiece in which a plurality of working areas is set and the robot that processes the workpiece. The relative positional relationship between the workpiece and the robot refers to a positional relationship in which the position of one of the workpiece and the robot is determined based on the position of the other. The working area refers to a portion on the workpiece to be processed by the robot. Each working area may be an area defined by a point, a line, or a surface.

The control assistance system virtually executes, for each of a plurality of candidate positional relationships that are candidates for the relative positional relationship, a process of the workpiece by the robot placed in the candidate positional relationship, by a simulation. The control assistance system identifies, for each of the plurality of candidate positional relationships, a set of one or more working areas processed under the candidate positional relationship based on a result of the simulation, as a working area set. The working area set refers to a set of one or more working areas processed by the robot while the workpiece and the robot are constrained in a certain relative positional relationship. In some examples, the control assistance system determines the relative positional relationship from the plurality of candidate positional relationships based on the working area set of each of the plurality of candidate positional relationships. In other examples, the control assistance system sets one of the plurality of working area sets as a working area group, which is a group of one or more working areas on the workpiece to be processed by the robot in the relative positional relationship. It may be therefore said that each working area set is a candidate for the working area group. The control assistance system may execute both the determination of the relative positional relationship and the setting of the working area group.

In a case where the plurality of working areas is set on the workpiece, the robot may efficiently process the workpiece by dividing these working areas into several groups and determining the relative positional relationship between the workpiece and the robot for each group. It is however difficult to manually perform such grouping of working areas and determination of the relative positional relationship. The control assistance system executes a simulation for each of the plurality of candidate positional relationships and, based on a result of the simulation, executes at least one of the grouping of working areas and the determination of the relative positional relationship. Such automation is expected to facilitate the planning of robot operations for efficiently processing the workpiece.

In some examples, the control assistance system controls the robot placed in a real working space so as to process the workpiece at a real position corresponding to the relative positional relationship, based on the determined relative positional relationship. Alternatively, the control assistance system controls the robot placed in the real working space so as to process a real working area group of the workpiece at a real position corresponding to the relative positional relationship, based on the relative positional relationship and the working area group. For example, the control assistance system generates an operation program based on the relative positional relationship (and the working area group) and controls the real robot based on the operation program. By using the control assistance system, the robot operations for efficiently processing the workpiece may be easily generated.

### Configuration of System

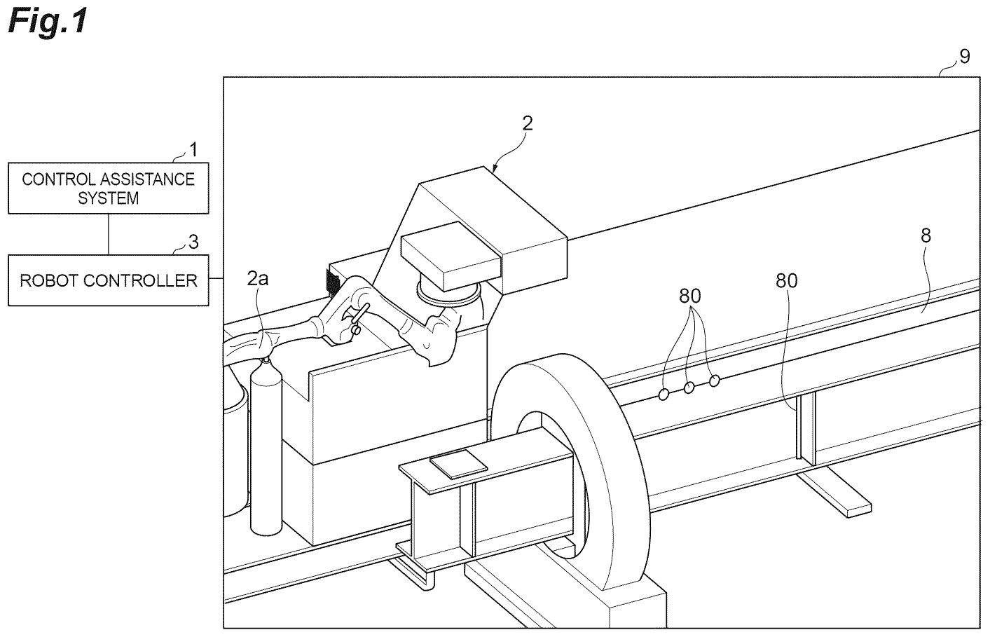

FIG. 1 is a diagram showing an example application of the control assistance system. A control assistance system 1 shown in this example determines a relative positional relationship between a real robot 2 in a real working space 9 and a real workpiece 8 in which a plurality of working areas 80 is set. The control assistance system 1 is connected to a robot controller 3 that controls the robot 2 via a communication network. The communication network may be a wired network or a wireless network. The communication network may include at least one of the Internet and an intranet. Alternatively, the communication network may be implemented simply by a single communication cable.

In the example of FIG. 1, the workpiece 8 is an H-steel, and the robot 2 performs welding in the plurality of working areas 80 on the H-steel. The robot 2 is capable of moving on a rail provided so as to extend along the H-steel. The robot 2 may be an autonomous mobile robot (AMR) or may be supported by an automated guided vehicle (AGV). The robot 2 may move in cooperation with a positioner that holds the workpiece 8.

The robot 2 is a device that receives power and performs a predetermined motion according to a purpose, thereby performing a useful work. In some examples, the robot 2 includes a plurality of joints, an arm, and an end effector 2a attached to a tip of the arm. The robot 2 processes the workpiece using the end effector 2a. Examples of the end effector 2a may include a welding gun and a screw fastening device. A joint axis is set for each of the plurality of joints. Some components of the robot 2, such as the arm and a pivoting unit, rotate about the joint axis, so that the robot 2 may change the position and posture of the end effector 2a within a predetermined range. In some examples, the robot 2 is a multi-axis serial link type vertical articulated robot. The robot 2 may be a six-axis vertical articulated robot, or may be a seven-axis vertical articulated robot in which one redundant axis is added to six axes. As described above, the robot 2 may be a self-propelled movable robot, for example, an autonomous mobile robot (AMR), or a robot supported by an automated guided vehicle (AGV). Alternatively, the robot 2 may be a stationary robot fixed at a predetermined place.

The robot controller 3 is a device that controls the robot 2 in accordance with an operation program generated in advance. In some examples, the robot controller 3 calculates a joint angle target value (angle target value of each joint of the robot 2) for matching the position and posture of the end effector 2a with a target value indicated by the operation program, and controls the robot 2 according to the angle target value.

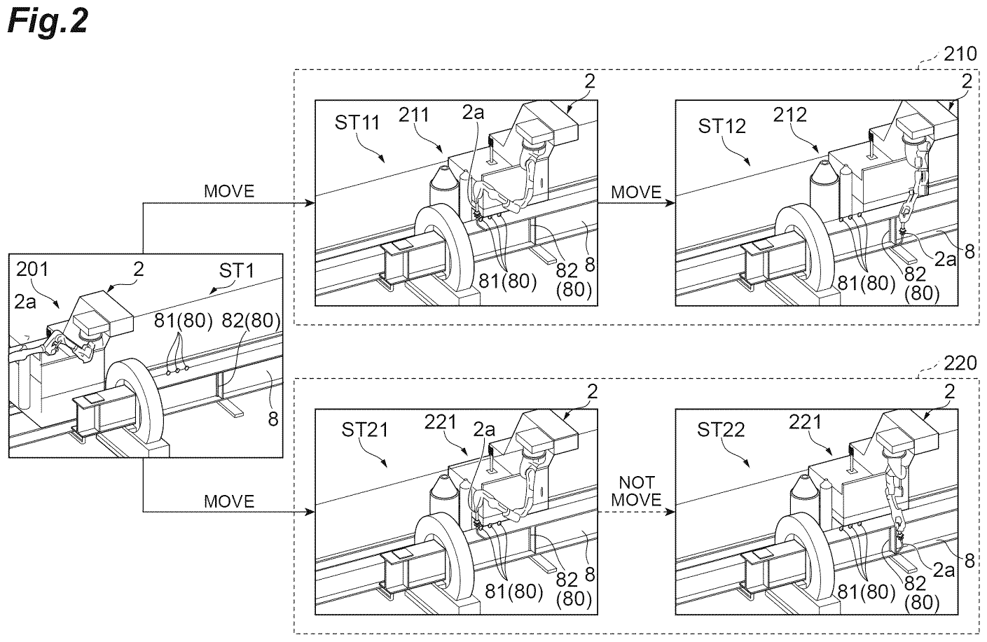

FIG. 2 is a diagram showing an example of relative positional relationship determined by the control assistance system 1. In state ST1, the robot 2 is placed at an initial position 201. In a conventional method 210, the position of the robot 2 with respect to the workpiece 8 may be determined such that the robot 2 moves to position 211 to process three point-like working areas 81 (state ST11), and then moves to position 212 to process one line-like working area 82 (state ST12). On the other hand, in a method 220 by the control assistance system 1, the relative positional relationship between the workpiece 8 and the robot 2 may be determined such that the robot 2 moves to position 221 to process the three working areas 81 (state ST21), and further processes the working area 82 at the position 221 (state ST22). Since the position of the robot 2 does not move between the states ST21 and ST22 by the determination, the method 220 by the control assistance system 1 may process the workpiece 8 more efficiently than the conventional method 210.

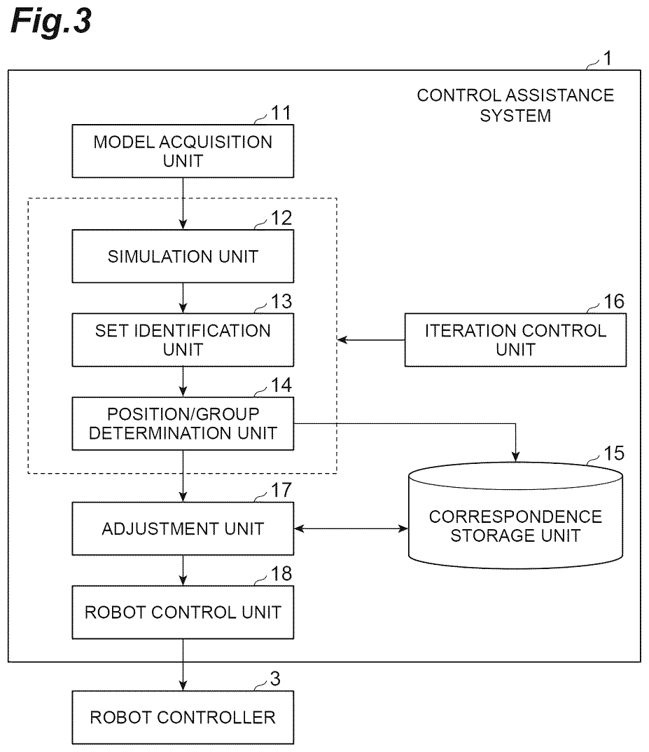

FIG. 3 is a diagram showing an example functional configuration of the control assistance system 1. In this example, the control assistance system 1 includes a model acquisition unit 11, a simulation unit 12, a set identification unit 13, a position/group determination unit 14, a correspondence storage unit 15, an iteration control unit 16, an adjustment unit 17, and a robot control unit 18 as functional elements.

The model acquisition unit 11 is a functional module that acquires model data used for the simulation. The simulation unit 12 is a functional module that virtually executes, for each of the plurality of candidate positional relationships, a predetermined process on the workpiece performed by the robot 2 placed in the candidate positional relationship, by the simulation. The simulation is a process that does not actually operate the robot 2 placed in the working space 9, but rather virtually represents the operations of the robot 2 on a computer. The set identification unit 13 is a functional module that identifies, for each of the plurality of candidate positional relationships, a set of one or more working areas having processed under the candidate positional relationship, as a working area set, based on a result of the simulation. The position/group determination unit 14 is a functional module that determines the relative positional relationship from the plurality of candidate positional relationships based on the working area set of each of the plurality of candidate positional relationships, and sets the working area set corresponding to the relative positional relationship as a working area group. The position/group determination unit 14 stores correspondence data indicating a combination of the relative positional relationship and the working area group in the correspondence storage unit 15. Therefore, the position/group determination unit 14 corresponds to the determination unit, grouping unit, and recording unit in the present disclosure. The correspondence storage unit 15 is a functional module that stores the correspondence data. The iteration control unit 16 is a functional module that controls the repetition of the processes of the simulation unit 12, set identification unit 13, and position/group determination unit 14. The adjustment unit 17 is a functional module that adjusts the relative positional relationship by an optimization process using the relative positional relationship as an initial value. The robot control unit 18 is a functional module that controls the robot 2 based on the adjusted relative positional relationship and the working area group.

The control assistance system 1 may be implemented by any type of computer. The computer may be a general-purpose computer such as a personal computer or a business server, or may be incorporated in a dedicated device that executes specific processing.

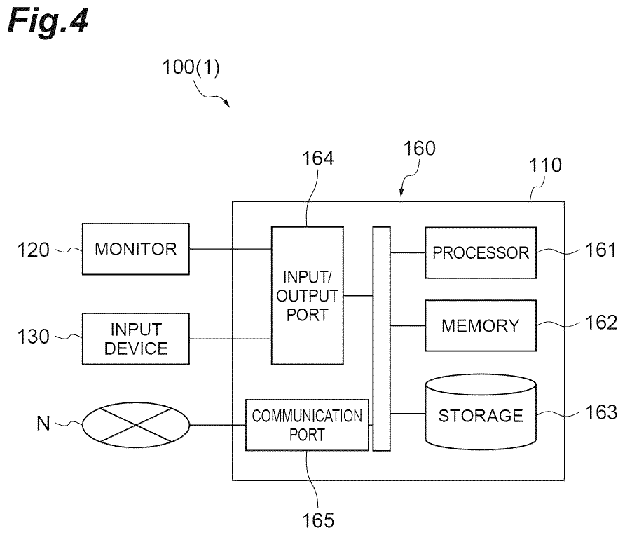

FIG. 4 is a diagram showing an example hardware configuration of a computer 100 used for the control assistance system 1. In this example, the computer 100 comprises a main body 110, a monitor 120, and an input device 130.

The main body 110 is a device having circuitry 160. The circuitry 160 has a processor 161, a memory 162, a storage 163, an input/output port 164, and a communication port 165. The number of each hardware component may be one or two or more. The storage 163 stores a program for configuring each functional module of the main body 110. The storage 163 is a computer-readable recording medium such as a hard disk, a nonvolatile semiconductor memory, a magnetic disk, or an optical disk. The memory 162 temporarily stores a program loaded from the storage 163, a calculation result of the processor 161, etc. The processor 161 configures each functional module by executing the program in cooperation with the memory 162. The input/output port 164 inputs and outputs electrical signals to and from the monitor 120 or the input device 130 in response to commands from the processor 161. The communication port 165 performs data communication with other devices such as the robot controller 3 via a communication network N in accordance with commands from the processor 161.

The monitor 120 is a device for displaying information output from the main body 110. For example, the monitor 120 is a device capable of graphic display, such as a liquid-crystal panel.

The input device 130 is a device for inputting information to the main body 110. Examples of the input device 130 include operation interfaces such as a keypad, a mouse, and a manipulation controller.

The monitor 120 and the input device 130 may be integrated as a touch panel. For example, the main body 110, the monitor 120, and the input device 130 may be integrated as a tablet computer.

Each functional module in the control assistance system 1 is implemented by loading a control assistance program on the processor 161 or the memory 162 and executing the program in the processor 161. The control assistance program includes codes for implementing each functional module of the control assistance system 1. The processor 161 operates the input/output port 164 and the communication port 165 according to the control assistance program, and executes reading and writing of data in the memory 162 or the storage 163.

The control assistance program may be provided by being recorded in a non-transitory recording medium such as a CD-ROM, a DVD-ROM, or a semiconductor memory. Alternatively, the control assistance program may be provided via a communication network as data signals superimposed on carrier waves.

### Control Assistance Method

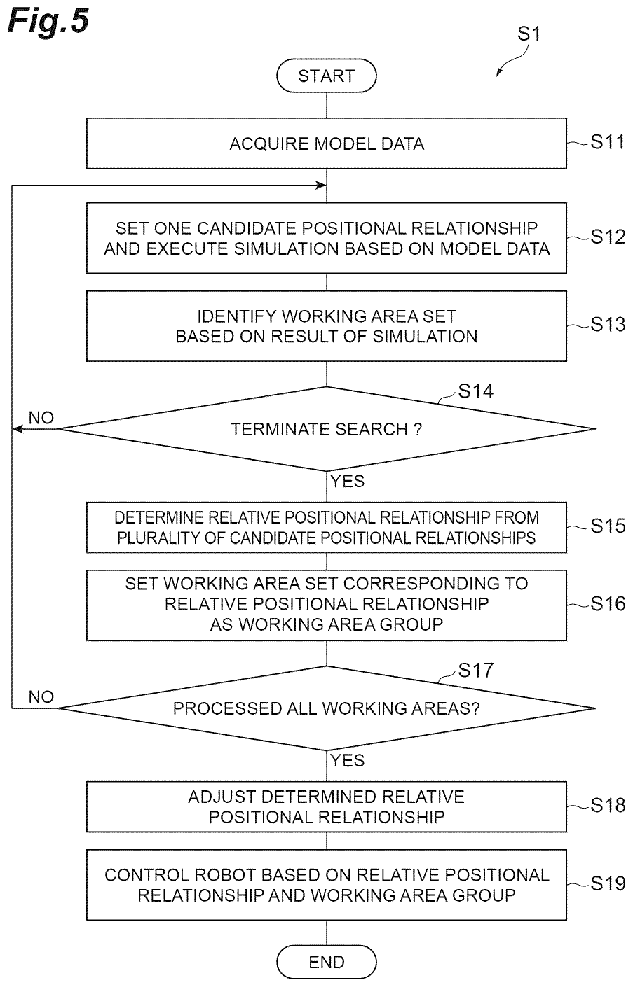

As an example of the control assistance method according to the present disclosure, an example of processing executed by the control assistance system 1 will be described with reference to FIG. 5. FIG. 5 is a flowchart showing that example as a processing flow S1. That is, the control assistance system 1 performs the processing flow S1.

In step S11, the model acquisition unit 11 acquires model data. In some examples, the model acquisition unit 11 acquires the model data including a workpiece model indicating the workpiece 8 and a robot model indicating the robot 2 having the end effector 2a. Both of these models are represented by electronic data. The workpiece model indicates at least a plurality of working areas on the workpiece 8, and may further indicate other attributes of the workpiece 8, such as a processing order of the plurality of working areas, a shape, and dimensions. The robot model indicates specifications for the robot 2 and the end effector 2a. The specification may include parameters related to structures of the robot 2 and the end effector 2a, such as a shape and dimensions, and parameters related to functions of the robot 2 and the end effector 2a, such as a movable range of each joint and performance of the end effector 2a.

In some examples, the model acquisition unit 11 acquires the model data designated by a user of the control assistance system 1. The model acquisition unit 11 may read the model data corresponding to the user instruction from a predetermined storage device such as the storage 163, or may receive the model data input by the user via the input device 130. In any case, in a case where the workpiece and the robot are designated by the user, the model acquisition unit 11 acquires the model data corresponding to that designation. For example, in a case where the robot 2 is able to process a plurality of types of workpieces 8, the user may cause the robot 2 to process the plurality of types of workpieces 8 while changing the type of the workpiece 8. In this case, in a case where the user designates the workpiece 8 to be processed next, the model acquisition unit 11 acquires the workpiece model of the designated workpiece 8.

In step S12, the simulation unit 12 sets one candidate positional relationship between the workpiece 8 and the robot 2 and executes a simulation based on this candidate positional relationship and the model data.

The simulation unit 12 generates a virtual space corresponding to the real working space 9, generates a virtual workpiece 8 based on the workpiece model, and generates a virtual robot 2 based on the robot model. The simulation unit 12 determines, based on a position of one of the virtual workpiece 8 and the virtual robot 2, a position of the other in order to set the candidate positional relationship. In some examples, the simulation unit 12 sets the candidate positional relationship based on an arrangement of the plurality of working areas on the workpiece 8 and an arrangement of one or more working areas that have not yet belonged to a working area group. In the present disclosure, a working area that has not yet belonged to the working area group is also referred to as a “remaining working area”. The simulation unit 12 may set the candidate positional relationship (a new candidate positional relationship) such that the robot 2 processes at least the working area to be processed first among the one or more remaining working areas.

In some examples, the simulation unit 12 sets the candidate positional relationship by an optimization method that optimizes the number of working areas constituting the working area set identified based on the simulation. The simulation unit 12 may use Bayesian optimization as the optimization method. The simulation unit 12 uses Gaussian process regression to estimate a function indicating a relationship between the candidate positional relationship and an evaluation value and calculate a variance indicating the uncertainty of the function. The simulation unit 12 uses the number of working areas as the evaluation value. The simulation unit 12 calculates a predetermined acquisition function based on a result of the Gaussian process regression. The simulation unit 12 sets the candidate positional relationship with the maximum acquisition function as the new candidate positional relationship. In other examples, the simulation unit 12 may set the candidate positional relationship at predetermined intervals or set the candidate positional relationship randomly.

The simulation unit 12 places the robot 2 and the workpiece 8 in the virtual space based on the set candidate positional relationship. The simulation unit 12 then virtually executes a predetermined process in at least one working area by the end effector 2a of the robot 2 placed in the candidate positional relationship, by a simulation according to a predetermined constraint condition. Examples of the predetermined process include processes that fix the workpiece 8 to another workpiece, such as welding and screw fastening. Examples of the constraint condition include that the robot 2 continues to take normal postures (i.e., operates normally) in the predetermined process and that no interference is detected. The interference refers to a phenomenon in which an object contacts or collides with another object. It should be noted that in a case where the robot attempts to process a workpiece, a contact between the robot and the workpiece is not interference. In the simulation, the robot 2 may process only one working area by the end effector 2a, or may process two or more working areas. The number of working areas processed by the robot 2 may be determined by the range in which the end effector 2a of the robot 2 placed in the candidate positional relationship is able to work and the positions of one or more working areas on the workpiece 8.

In step S13, the set identification unit 13 identifies the working area set based on the result of the simulation. The set identification unit 13 acquires the result of the simulation, and identifies a set of one or more working areas having processed under the candidate positional relationship in the simulation, as the working area set. The set identification unit 13 temporarily stores a pair of the candidate positional relationship and the working area set.

In some examples, the set identification unit 13 records, for each of the plurality of working areas (one or more remaining working areas), the number of times the working area is processed by the end effector 2a in the simulation, as a processed count. The set identification unit 13 increments the processed count corresponding to each working area processed in one simulation by one.

In step S14, the iteration control unit 16 determines whether to terminate a search including the simulation and the identification of the working area set, based on a predetermined termination condition. The termination condition may be that a predetermined number of candidate positional relationships have been set, or that a predetermined calculation time has elapsed. In a case of setting the candidate positional relationship by the optimization method, the termination condition may be that the difference between the evaluation value obtained last time and the evaluation value obtained this time is less than a predetermined threshold, that is, the evaluation value has stagnated or converged. Alternatively, the termination condition may be that an evaluation value that meets a predetermined criterion has been obtained. Alternatively, the termination condition may be that the uncertainty (e.g., variance) of the overall relationship between the candidate positional relationship and the evaluation value has become less than a predetermined threshold.

In a case where the search is to be continued (NO in step S14), the process returns to step S12. In repeated step S12, the simulation unit 12 sets a new candidate positional relationship and executes the simulation based on that candidate positional relationship and the model data. In repeated step S13, the set identification unit 13 identifies the working area set based on the result of the simulation and stores a new pair of the candidate positional relationship and the working area set. The set identification unit 13 increments the processed count corresponding to each working area processed in the simulation by one.

In a case where the search is to be terminated (YES in step S14), the process proceeds to step S15. In step S15, the position/group determination unit 14 determines the relative positional relationship from the plurality of candidate positional relationships based on the working area set of each of the plurality of candidate positional relationships.

The position/group determination unit 14 may determine the relative positional relationship based on the number nw of working areas constituting the working area set in each of the plurality of candidate positional relationships. For example, the position/group determination unit 14 may determine the candidate positional relationship in which the working area set having the largest number nw is obtained, as the relative positional relationship. In a case where two or more candidate positional relationships corresponding to two or more working area sets having the largest number nw are obtained, the position/group determination unit 14 may determine one of the two or more candidate positional relationships as the relative positional relationship based on a physical quantity related to the motion of the robot 2. Examples of the physical quantity include the distance or time (so-called playback time) required for the motion.

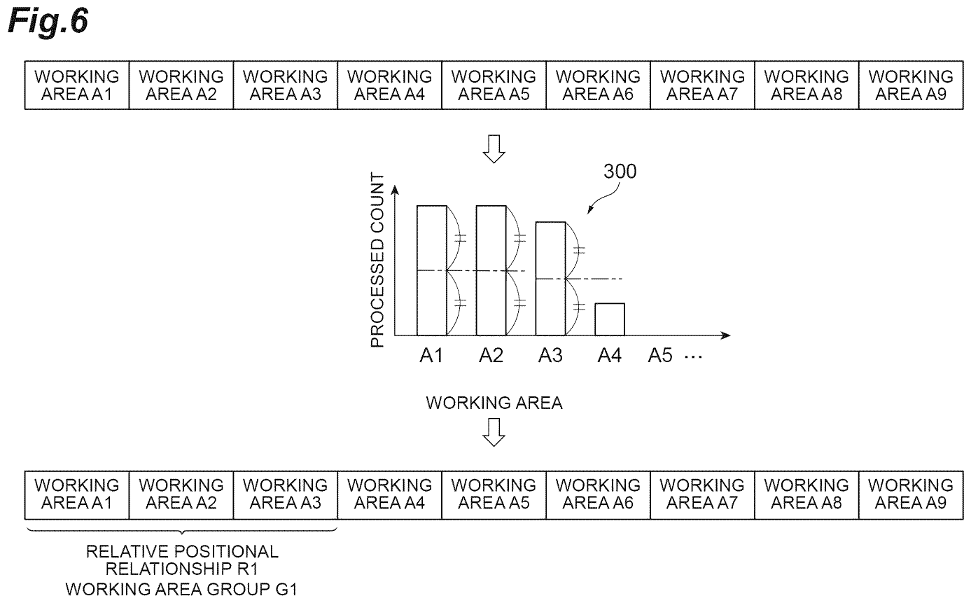

The position/group determination unit 14 may determine the relative positional relationship based on the processed count of each of the plurality of working areas. This process will be described with reference to FIG. 6. FIG. 6 is a diagram showing an example method of determining the relative positional relationship based on the processed count.

In the example of FIG. 6, it is assumed that nine working areas A1 to A9 are processed in this order. The simulation unit 12 executes the simulation for each of the plurality of candidate positional relationships. In each simulation, the set identification unit 13 identifies the working area set and increments the processed count for at least one working area by one.

It is assumed that when the iteration control unit 16 determines to terminate the search, the processed count of each of the nine working areas is obtained as shown in a graph 300. The position/group determination unit 14 may select a working area set constituted by one or more working areas whose processed count meets a predetermined criterion and determine the candidate positional relationship corresponding to the selected working area set as the relative positional relationship. For example, the position/group determination unit 14 may refer to a transition of the processed count according to the processing order of the working areas and identify a set of one or more working areas whose degree of reduction in the processed count is less than a predetermined threshold Td as the working area set. The threshold Td may be defined by the ratio of the processed count in the second working area, which is next to the first working area, to the processed count in the first working area. In the example of FIG. 6, if the threshold Td is ½, the degree of reduction in the processed count from the working area A1 to the working area A2 is less than ½, and the degree of reduction in the processed count from the working area A2 to the working area A3 is also less than ½. However, the degree of reduction in the processed count from the working area A3 to the working area A4 is ½ or more. Therefore, the position/group determination unit 14 selects a working area set constituted by the three working areas A1 to A3 and determines the candidate positional relationship corresponding to this working area set as the relative positional relationship R1. If two or more candidate positional relationships are obtained that corresponds to the working area set constituted by the working areas A1 to A3, the position/group determination unit 14 may determine one of the two or more candidate positional relationships as the relative positional relationship R1, based on a physical quantity related to a motion of the robot 2. Examples of the physical quantity include the distance or time (playback time) required for the motion.

Referring back to FIG. 5, in step S16, the position/group determination unit 14 sets the working area set corresponding to the determined relative positional relationship, among the plurality of working area set, as a working area group. In the example of FIG. 6, the position/group determination unit 14 sets a working area group G1 constituted by the three working areas A1 to A3 corresponding to the relative positional relationship R1. The position/group determination unit 14 records correspondence data indicating a combination of the working area group and the relative positional relationship in the correspondence storage unit 15.

In step S17, the iteration control unit 16 determines whether all the working areas have been processed. Here, the phrase “all the working areas have been processed” refers to the fact that the working area group has been set for each of the plurality of working areas of the workpiece 8.

In a case where there are one or more remaining working areas that are not processed by the robot in one or more of the determined relative positional relationships (NO in step S17), the iteration control unit 16 causes the simulation unit 12, the set identification unit 13, and the position/group determination unit 14 to execute an iterative process for the remaining working areas. In this case, the process returns to step S12. In repeated steps S12 to S14, the simulation unit 12 virtually executes the predetermined process in at least one of the remaining working areas by the simulation, for each of a plurality of new candidate positional relationships that are candidates for a new relative positional relationship of the robot 2 with respect to the workpiece 8. The set identification unit 13 identifies the working area set for each of the plurality of new candidate positional relationships. The set identification unit 13 may record the processed count for each of the one or more remaining working areas. In repeated steps S15 and S16, the position/group determination unit 14 determines one new relative positional relationship from the plurality of new candidate positional relationships based on the working area set of each of the plurality of new candidate positional relationships. In addition, the position/group determination unit 14 sets the working area set corresponding to the new relative positional relationship as a new working area group. The position/group determination unit 14 records the correspondence data indicating a combination of the new working area group and the new relative positional relationship in the correspondence storage unit 15.

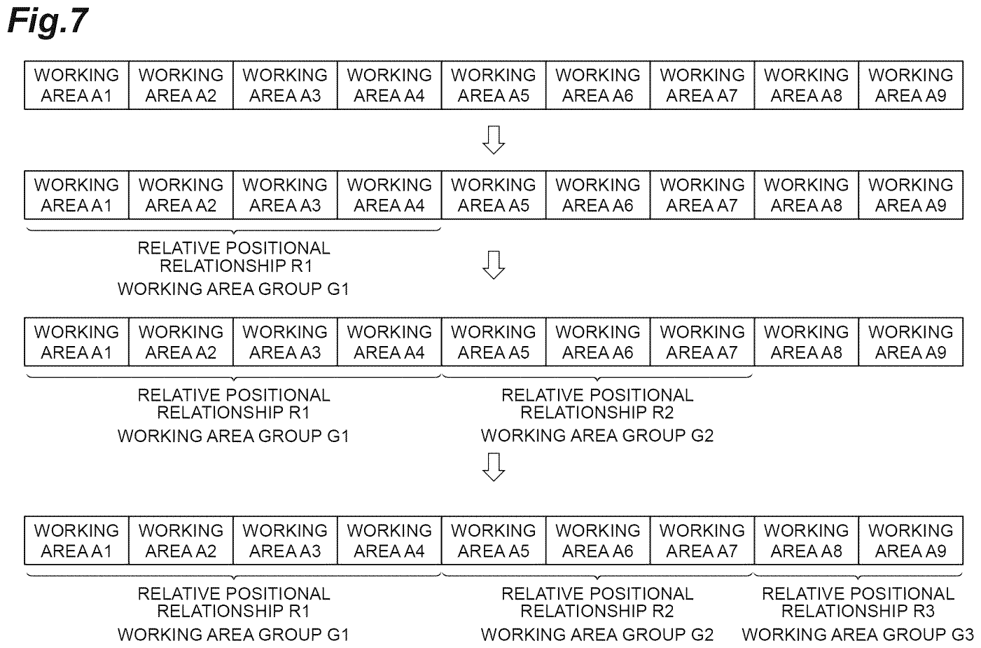

The iteration control unit 16 causes the simulation unit 12, the set identification unit 13, and the position/group determination unit 14 to execute the corresponding processing until all the plurality of working areas belongs to any of the working area groups. FIG. 7 is a diagram showing an example iterative process for determining the relative positional relationship and setting the working area group. In this example, it is assumed that the nine working areas A1 to A9 are processed in this order. In the first loop process of steps S12 to S16, the control assistance system 1 determines the candidate positional relationship corresponding to the working area set constituted by the four working areas A1 to A4 as a relative positional relationship R1 and sets that working area set as a working area group G1. The control assistance system 1 executes the second loop process of steps S12 to S16 for the remaining working areas A5 to A9. In this loop process, the control assistance system 1 determines the candidate positional relationship corresponding to the working area set constituted by the three working areas A5 to A7 as a relative positional relationship R2 and sets the working area set as a working area group G2. The control assistance system 1 executes the third loop process of steps S12 to S16 for the remaining working areas A8 and A9. In this loop process, the control assistance system 1 determines the candidate positional relationship corresponding to the working area set constituted by the two working areas A8 and A9 as a relative positional relationship R3 and sets the working area set as a working area group G3.

Referring back to FIG. 5, in a case where all the working areas have been processed (YES in step S17), the process proceeds to step S18. In step S18, the adjustment unit 17 adjusts the determined relative positional relationship. In some examples, the adjustment unit 17 adjusts, for each of the one or more relative positional relationships, a positional relationship between the workpiece and the robot for processing one or more working areas corresponding to the relative positional relationship, by an optimization process using the relative positional relationship as an initial value. The adjustment unit 17 may use Bayesian optimization as the optimization process. The adjustment unit 17 uses Gaussian process regression to estimate a function indicating a relationship between the positional relationship and an evaluation value and calculates a variance indicating the uncertainty of the function. The adjustment unit 17 may use a physical quantity related to a motion of the robot 2 as the evaluation value. Examples of the physical quantity include the distance or time (playback time) required for the motion. The adjustment unit 17 calculates a predetermined acquisition function based on the result of the Gaussian process regression. The adjustment unit 17 identifies one positional relationship with the maximum acquisition function and replaces the determined relative positional relationship with the identified positional relationship. This replacement is an example of the adjustment of the relative positional relationship.

In step S19, the robot control unit 18 controls the real robot 2 based on the relative positional relationship and the working area group. In a case where all the working areas have been processed, the correspondence storage unit 15 stores one or more correspondences (combinations) of the working area group and the relative positional relationship. The stored one or more correspondences indicate that all the plurality of working areas belongs to any of the working area groups.

The robot control unit 18 generates an operation program for controlling the real robot 2 based on the adjusted relative positional relationship and the working area group. The robot control unit 18 generates, for each of the one or more relative positional relationships, the operation program for causing the robot 2 to process the working area group corresponding to the relative positional relationship. The robot control unit 18 generates the operation program based on the one or more correspondences (combinations) of the working area group and the relative positional relationship stored in the correspondence storage unit 15. In some examples, the robot control unit 18 generates the operation program for causing the robot 2 to move to a stop position in the working space 9 corresponding to the relative positional relationship and process the corresponding working area group of the workpiece 8 at the stop position. The operation program includes data for controlling the robot 2, for example, a path indicating a trajectory of the robot 2. The trajectory of the robot 2 refers to a path of motion of the robot 2 or a component thereof. For example, the trajectory of the robot 2 may be a trajectory of a tip portion or the end effector 2a.

The robot control unit 18 controls the real robot 2 based on the operation program. The robot control unit 18 controls the robot 2 placed in the working space 9 so as to process the workpiece 8 in one or more real positional relationships in the real working space 9 corresponding to the one or more relative positional relationships. That is, the robot control unit 18 executes the control based on the one or more correspondences (combinations) of the working area group and the relative positional relationship stored in the correspondence storage unit 15. For example, the robot control unit 18 controls the real robot 2 so as to move to a stop position in the real working space 9 corresponding to the relative positional relationship and process the workpiece 8 in one or more working areas at the stop position. The robot control unit 18 outputs the operation program to the robot controller 3 to cause the robot controller 3 to control the robot 2. The robot controller 3 operates the robot 2 based on the operation program.

### Additional Examples

It is to be understood that not all aspects, advantages and features described herein may necessarily be achieved by, or included in, any one particular example. Indeed, having described and illustrated various examples herein, it should be apparent that other examples may be modified in arrangement and detail.

The control assistance system may not adjust the determined relative positional relationship. Alternatively, the control assistance system may output the relative positional relationship to another computer system such as a robot control system, and the other computer system may control the real robot based on the relative positional relationship. That is, the control assistance system may not include a functional module corresponding to at least one of the adjustment unit 17 and the robot control unit 18.

In the above examples, the control assistance system 1 determines both the relative positional relationship and the working area group, but the control assistance system may not determine one of the relative positional relationship and the working area group.

The hardware configuration of the system is not limited to a manner in which each functional module is realized by executing a program. For example, at least part of the above-described functional modules may be configured by a logic circuit specialized for the function(s), or may be configured by an application specific integrated circuit (ASIC) in which the logic circuits are integrated.

The processing procedure of the method executed by the at least one processor is not limited to the above examples. For example, some of the steps or processes described above may be omitted, or the steps may be executed in a different order. In addition, any two or more of the above-described steps may be combined, or some of the steps may be modified or deleted. Alternatively, another step may be executed in addition to the above-described steps.

When a magnitude relationship between two numerical values is compared in a computer system or a computer, either of two criteria of “equal to or greater than” and “greater than” may be used, and either of two criteria of “equal to or less than” and “less than” may be used.

### Appendix

As can be understood from the various examples described above, the present disclosure includes the following aspects.
(Appendix 1) A control assistance system for assisting control of a robot capable of changing a relative positional relationship between a workpiece and the robot that processes the workpiece, the system comprising:
a simulation unit configured to virtually execute, for each of a plurality of candidate positional relationships that are candidates for the relative positional relationship between the workpiece in which a plurality of working areas is set and the robot, a predetermined process in at least one of the working areas by an end effector of the robot placed in the candidate positional relationship, by a simulation based on a workpiece model indicating the plurality of working areas of the workpiece and a robot model indicating the robot having the end effector;
an identification unit configured to identify, for each of the plurality of candidate positional relationships, a set of one or more of the working areas having processed under the candidate positional relationship in the simulation, as a working area set; and
a determination unit configured to determine the relative positional relationship from the plurality of candidate positional relationships based on the working area set of each of the plurality of candidate positional relationships.
(Appendix 2) The control assistance system according to appendix 1, wherein the simulation unit is configured to set the candidate positional relationships by an optimization method that optimizes a number of the working areas constituting the working area set identified based on the simulation.
(Appendix 3) The control assistance system according to appendix 1 or 2, wherein the determination unit is configured to determine the relative positional relationship based on a number of the working areas constituting the working area set in each of the plurality of candidate positional relationships.
(Appendix 4) The control assistance system according to any one of appendices 1 to 3,
wherein the identification unit is configured to identify, for each of the plurality of working areas, a number of times the working area is processed by the end effector in the simulation, as a processed count, and
wherein the determination unit is configured to determine the relative positional relationship based on the processed count of each of the plurality of working areas.
(Appendix 5) The control assistance system according to appendix 4, wherein the determination unit is configured to:
select the working area set constituted by one or more of the working areas whose processed count meets a predetermined criterion; and
determine the candidate positional relationship corresponding to the selected working area set as the relative positional relationship.
(Appendix 6) The control assistance system according to any one of appendices 1 to 5, further comprising an iteration control unit configured to, in a case where there are one or more remaining working areas that are not processed by the robot in one or more of the relative positional relationships, cause the simulation unit, the identification unit, and the determination unit to execute an iterative process for the one or more remaining working areas, and
wherein the simulation unit is configured to, in the iteration process, virtually execute the predetermined process in at least one of the one or more remaining working areas by the simulation, for each of a plurality of new candidate positional relationships that are candidates for a new relative positional relationship of the robot with respect to the workpiece, and
wherein the identification unit is configured to, in the iteration process, identify the working area set for each of the plurality of new candidate positional relationships, and
wherein the determination unit is configured to, in the iteration process, determine the new relative positional relationship from the plurality of new candidate positional relationships based on the working area set of each of the plurality of new candidate positional relationships.
(Appendix 7) The control assistance system according to any one of appendices 1 to 6, further comprising:
a grouping unit configured to set the working area set corresponding to the determined relative positional relationship, as a working area group that is a group of one or more of the working areas to be processed by the robot in the relative positional relationship; and
a recording unit configured to record a correspondence between the working area group and the relative positional relationship in a predetermined storage unit.
(Appendix 8) The control assistance system according to appendix 7, further comprising an iteration control unit configured to cause the simulation unit, the identification unit, the determination unit, and the grouping unit to execute corresponding processing until all the plurality of working areas belongs to any of the working area groups.
(Appendix 9) The control assistance system according to any one of appendices 1 to 8, further comprising an adjustment unit configured to adjust the determined relative positional relationship by an optimization process using the determined relative positional relationship as an initial value.
(Appendix 10) The control assistance system according to any one of appendices 1 to 9, further comprising a robot control unit configured to control the robot placed in a real working space so as to move to a stop position in the real working space corresponding to the determined relative positional relationship and process the workpiece in one or more of the working areas at the stop position.
(Appendix 11) A control assistance system for assisting control of a robot capable of changing a relative positional relationship between a workpiece and the robot that processes the workpiece, the system comprising:
a simulation unit configured to virtually execute, for each of a plurality of candidate positional relationships that are candidates for the relative positional relationship between the workpiece in which a plurality of working areas is set and the robot, a predetermined process in at least one of the working areas by an end effector of the robot placed in the candidate positional relationship, by a simulation based on a workpiece model indicating the plurality of working areas of the workpiece and a robot model indicating the robot having the end effector;
an identification unit configured to identify, for each of the plurality of candidate positional relationships, a set of one or more of the working areas having processed under the candidate positional relationship in the simulation, as a working area set; and
a grouping unit configured to set one of a plurality of the working area sets, as a working area group that is a group of one or more of the working areas to be processed by the robot in the relative positional relationship.
(Appendix 12) A control assistance method executable by a control assistance system that includes at least one processor and assists control of a robot capable of changing a relative positional relationship between a workpiece and the robot that processes the workpiece, the method comprising:
virtually executing, for each of a plurality of candidate positional relationships that are candidates for the relative positional relationship between the workpiece in which a plurality of working areas is set and the robot, a predetermined process in at least one of the working areas by an end effector of the robot placed in the candidate positional relationship, by a simulation based on a workpiece model indicating the plurality of working areas of the workpiece and a robot model indicating the robot having the end effector;
identifying, for each of the plurality of candidate positional relationships, a set of one or more of the working areas having processed under the candidate positional relationship in the simulation, as a working area set; and
determining the relative positional relationship from the plurality of candidate positional relationships based on the working area set of each of the plurality of candidate positional relationships.
(Appendix 13) A control assistance program causing a computer to function as a control assistance system that assists control of a robot capable of changing a relative positional relationship between a workpiece and the robot that processes the workpiece, the program causing the computer to execute:
virtually executing, for each of a plurality of candidate positional relationships that are candidates for the relative positional relationship between the workpiece in which a plurality of working areas is set and the robot, a predetermined process in at least one of the working areas by an end effector of the robot placed in the candidate positional relationship, by a simulation based on a workpiece model indicating the plurality of working areas of the workpiece and a robot model indicating the robot having the end effector;
identifying, for each of the plurality of candidate positional relationships, a set of one or more of the working areas having processed under the candidate positional relationship in the simulation, as a working area set; and
determining the relative positional relationship from the plurality of candidate positional relationships based on the working area set of each of the plurality of candidate positional relationships.

According to appendices 1, 12 and 13, for each of the plurality of candidate positional relationships, the processing of the workpiece by the robot is virtually executed by the simulation, and the set (working area set) of working areas processed under the candidate positional relationship is identified. That is, the number of working areas processed in each candidate positional relationship is identified as each working area set. Since the relative positional relationship is determined based on those working area sets, the planning of robot operations to efficiently process the workpiece may be facilitated.

According to appendix 2, since the candidate positional relationship is obtained by the optimization method, the candidate positional relationship that is expected to efficiently process the workpiece may be set automatically and efficiently. As a result, the time required to determine the relative positional relationship may be shortened.

The number of working areas that are able to be processed at one position may be closely related to the efficiency of processing the entire workpiece. According to appendix 3, by determining the relative positional relationship focusing on the number of working areas, the position of the robot that is expected to efficiently process the workpiece may be determined automatically.

According to appendix 4, the relative positional relationship is determined considering the processed count of each working area obtained by repeating the simulation while changing the candidate positional relationship. The processed count may be useful in determining the set of working areas that are desirable to be processed at one position. By considering the processed count, the position of the robot that is more reliably expected to efficiently process the workpiece may be determined.

The working area set whose processed count meets the predetermined criterion is expected to contribute to the efficient processing of the workpiece. According to appendix 5, by determining the candidate positional relationship corresponding to such a working area set as the relative positional relationship, the position of the robot that is more reliably expected to efficiently process the workpiece may be determined.

According to appendix 6, the plurality of relative positional relationships of the robot with respect to the workpiece are determined. Therefore, even for a workpiece that needs to be processed while the robot moves to multiple locations, a plurality of relative positional relationships that is expected to achieve efficient processing may be determined. For example, the relative positional relationship may be determined for a workpiece in which the working areas are scattered over a wider range than the movable range of the robot at one location, or for a workpiece with a complex shape that makes it unable to process all the working areas at one location.

According to appendix 7, since one or more working areas processed under the relative positional relationship are grouped, the correspondence between the relative positional relationship and the one or more working areas to be processed may be managed. Such management of the working areas may also contribute to the robot operations for efficiently processing the workpiece. In addition, a working area group with high processing efficiency, which is difficult for humans to conceive, may be determined automatically.

According to appendix 8, the working area group is set for each of the plurality of working areas. Therefore, even for a workpiece that needs to be processed while the robot moves to multiple locations, a plurality of working area groups that is expected to achieve efficient processing may be set. For example, the working area group may be determined for a workpiece in which the working areas are scattered over a wider range than the movable range of the robot at one location, or for a workpiece with a complex shape that makes it unable to process all the working areas at one location. In addition, a combination of working area groups with high processing efficiency, which is difficult for humans to conceive, may be determined automatically.

According to appendix 9, instead of adopting the relative positional relationship obtained by the simulation as it is, the relative positional relationship between the workpiece and the robot is finally obtained by the optimization process using the simulation result. This process may contribute to realizing more appropriate robot control.

According to Appendix 10, based on the determined relative positional relationship, the real workpiece may be processed more efficiently by the real robot.

According to appendix 11, for each of the plurality of candidate positional relationships, the processing of the workpiece by the robot is virtually executed by the simulation, and the set (working area set) of working areas processed under the candidate positional relationship is identified. That is, the number of working areas processed in each candidate positional relationship is identified as each working area set. Since one of these working area sets is automatically set as the working area group, the planning of robot operations for efficiently processing the workpiece may be facilitated.

What is claimed is:

1. A control assistance system for assisting control of a robot capable of changing a relative positional relationship between a workpiece and the robot that processes the workpiece, the system comprising circuitry configured to:
acquire a workpiece model indicating a plurality of working areas of the workpiece;
acquire a robot model indicating the robot having an end effector;
virtually execute, for each of a plurality of candidate positional relationships that are candidates for the relative positional relationship between the workpiece and the robot, a predetermined process in at least one of the working areas by the end effector of the robot placed in the candidate positional relationship, by a simulation based on the workpiece model and the robot model;
identify, for each of the plurality of candidate positional relationships, a set of one or more of the working areas having processed under the candidate positional relationship in the simulation, as a working area set;
determine the relative positional relationship from the plurality of candidate positional relationships based on the working area set of each of the plurality of candidate positional relationships; and
control the robot placed in a real working space, based on the determined relative positional relationship.

2. The control assistance system according to claim 1, wherein the circuitry is configured to set each of the plurality of candidate positional relationships by an optimization method that optimizes a number of the working areas constituting the working area set identified based on the simulation.

3. The control assistance system according to claim 2,
wherein the optimization method is Bayesian optimization, and
wherein the circuitry is configured to, in the Bayesian optimization:
estimate a function indicating a relationship between the candidate positional relationships and the number of the working areas using Gaussian process regression;
calculate an acquisition function based on a result of the Gaussian process regression; and
set a new candidate positional relationship based on the acquisition function.

4. The control assistance system according to claim 1, wherein the circuitry is configured to virtually execute the predetermined process by the simulation according to a constraint condition that the robot operates normally and no interference is detected.

5. The control assistance system according to claim 1, wherein the circuitry is configured to determine the relative positional relationship based on a number of the working areas constituting the working area set in each of the plurality of candidate positional relationships.

6. The control assistance system according to claim 5, wherein the circuitry is configured to determine, as the relative positional relationship, the candidate positional relationship in which the working area set having a largest number of the working areas is obtained.

7. The control assistance system according to claim 1, wherein the circuitry is configured to:
identify, for each of the plurality of working areas, a number of times the working area is processed by the end effector in the simulation, as a processed count; and
determine the relative positional relationship based on the processed count of each of the plurality of working areas.

8. The control assistance system according to claim 7, wherein the circuitry is configured to:
select the working area set constituted by one or more of the working areas whose processed count meets a predetermined criterion; and
determine the candidate positional relationship corresponding to the selected working area set as the relative positional relationship.

9. The control assistance system according to claim 8,
wherein the workpiece model further indicates a processing order of the plurality of working areas, and
wherein the circuitry is configured to:
refer to a transition of the processed count according to the processing order of the plurality of working areas; and
select the working area set constituted by the one or more working areas whose degree of reduction in the processed count is less than a predetermined threshold.

10. The control assistance system according to claim 8, wherein the circuitry is configured to, in a case where two or more of the candidate positional relationships corresponding to the working area set constituted by the one or more working areas whose processed count meets the predetermined criterion are obtained, determine one of the obtained two or more candidate positional relationships as the relative positional relationship, based on a physical quantity related to a motion of the robot.

11. The control assistance system according to claim 1,
wherein the circuitry is configured to, in a case where there are one or more remaining working areas that are not processed by the robot in one or more of the relative positional relationships, execute an iterative process for the one or more remaining working areas, and
wherein the iterative process includes:
virtually executing the predetermined process in at least one of the one or more remaining working areas by the simulation, for each of a plurality of new candidate positional relationships that are candidates for a new relative positional relationship of the robot with respect to the workpiece;
identifying the working area set for each of the plurality of new candidate positional relationships; and
determining the new relative positional relationship from the plurality of new candidate positional relationships based on the working area set of each of the plurality of new candidate positional relationships.

12. The control assistance system according to claim 11, wherein the circuitry is configured to set the new candidate positional relationships such that the robot processes at least the working area to be processed first among the one or more remaining working areas.

13. The control assistance system according to claim 1, wherein the circuitry is configured to:
set the working area set corresponding to the determined relative positional relationship, as a working area group that is a group of one or more of the working areas to be processed by the robot in the relative positional relationship; and
record a correspondence between the working area group and the relative positional relationship in a predetermined storage.

14. The control assistance system according to claim 13, wherein the circuitry is configured to:
execute an iterative process including the executing, the identifying, the determining and the setting, until all of the plurality of working areas belongs to any of the working area groups; and
record, in the storage, one or more of the correspondences between the working area groups and the relative positional relationships, wherein the one or more correspondences indicate that all of the plurality of working areas belongs to any of the working area groups.

15. The control assistance system according to claim 14, wherein the circuitry is configured to control the robot based on the one or more correspondences so as to process the workpiece in one or more real positional relationships in the real working space corresponding to one or more of the relative positional relationships.

16. The control assistance system according to claim 1, wherein the circuitry is configured to:
adjust the determined relative positional relationship by an optimization process using the determined relative positional relationship as an initial value; and
control the robot based on the adjusted relative positional relationship.

17. The control assistance system according to claim 16,
wherein the optimization process is Bayesian optimization, and
wherein the circuitry is configured to, in the Bayesian optimization:
estimate a function indicating a relationship between a positional relationship and a physical quantity related to a motion of the robot, using Gaussian process regression;
calculate an acquisition function based on a result of the Gaussian process regression;
identify one positional relationship based on the acquisition function; and
replace the determined relative positional relationship with the identified one positional relationship, as the adjustment of the determined relative positional relationship.

18. The control assistance system according to claim 1, wherein the circuitry is configured to control the robot placed in the real working space, so as to move to a stop position in the real working space corresponding to the determined relative positional relationship and process the workpiece in one or more of the working areas at the stop position.

19. A method executable by a control assistance system that includes at least one processor and assists control of a robot capable of changing a relative positional relationship between a workpiece and the robot that processes the workpiece, the method comprising:
acquiring a workpiece model indicating a plurality of working areas of the workpiece;
acquiring a robot model indicating the robot having an end effector;
virtually executing, for each of a plurality of candidate positional relationships that are candidates for the relative positional relationship between the workpiece and the robot, a predetermined process in at least one of the working areas by the end effector of the robot placed in the candidate positional relationship, by a simulation based on the workpiece model and the robot model;
identifying, for each of the plurality of candidate positional relationships, a set of one or more of the working areas having processed under the candidate positional relationship in the simulation, as a working area set;
determining the relative positional relationship from the plurality of candidate positional relationships based on the working area set of each of the plurality of candidate positional relationships; and
controlling the robot placed in a real working space, based on the determined relative positional relationship.

20. A non-transitory computer-readable storage medium storing processor-executable instructions for causing a computer to function as a control assistance system that assists control of a robot capable of changing a relative positional relationship between a workpiece and the robot that processes the workpiece, the instructions causing the computer to execute:
acquiring a workpiece model indicating a plurality of working areas of the workpiece;
acquiring a robot model indicating the robot having an end effector;
virtually executing, for each of a plurality of candidate positional relationships that are candidates for the relative positional relationship between the workpiece and the robot, a predetermined process in at least one of the working areas by the end effector of the robot placed in the candidate positional relationship, by a simulation based on the workpiece model and the robot model;
identifying, for each of the plurality of candidate positional relationship, a set of one or more of the working areas having processed under the candidate positional relationship in the simulation, as a working area set;
determining the relative positional relationship from the plurality of candidate positional relationships based on the working area set of each of the plurality of candidate positional relationships; and
controlling the robot placed in a real working space, based on the determined relative positional relationship.
